(19) United States
(12) Patent Application Publication
(10) Pub. No.: US 2017/0061216 A1
(43) Pub. Date: Mar. 2, 2017

(54) EVENT SENSING METHOD AND SYSTEM USING DCT COEFFICIENT IN SURVEILLANCE CAMERA

(71) Applicants: Center for Integrated Smart Sensors Foundation, Daejeon (KR); Handong Global University Industry-Academic Cooperation Foundation, Gyeongsangbuk-do (KR)

(72) Inventors: Wook Hyung KIM, Daejeon (KR); Kang YI, Gyeongsangbuk-do (KR); Chong Min KYUNG, Daejeon (KR); Jong Pil JUNG, Daejeon (KR)

(21) Appl. No.: 15/118,585

(22) PCT Filed: Mar. 9, 2015
(86) PCT No.: PCT/KR2015/002240

§ 371 Date: Aug. 12, 2016

(30) Foreign Application Priority Data
Mar. 17, 2014 (KR) 10-2014-0031069

(51) Int. Cl. G06K 9/00; G06T 7/20; H04N 7/18; G06K 9/52

(52) U.S. Cl. CPC G06K 9/00771; G06K 9/522; G06T 7/206; H04N 7/183; G06T 2207/20052; G06T 2207/30232

(57) ABSTRACT

An event sensing method using a frequency component in a surveillance camera comprises the steps of: obtaining at least one of a plurality of frequency components for a first frame of a digital image and at least one of a plurality of frequency components for a second frame after the first frame of the digital image; and sensing whether an event occurs in a digital image corresponding to the second frame by using the at least one of the plurality of frequency components for the first frame and the at least one of the plurality of frequency components for the second frame.

### TECHNICAL FIELD

Embodiments of the inventive concepts described herein relate to an event sensing system and method using a frequency component in a surveillance camera, and more particularly, relate to technologies for a motion event sensing system and method for minimizing an influence due to an ambient lighting change in a digital image using a discrete cosine transform (DCT) coefficient.

### BACKGROUND ART

A conventional event sensing technology in a surveillance camera system senses an event using a simple difference (SD) scheme of comparing pixel values of each of subsequent frames of a digital image generated from an image sensor.

However, the event sensing technology using the SD scheme does not distinguish an object change and a lighting change and has a weakness for noises. Also, since the other conventional event sensing technologies except for the event sensing technology using the SD scheme have a high amount of calculation, it is difficult to perform a real-time operation.

Therefore, in the specification, a technology of accurately distinguishing and sensing a lighting object and an object change by a low amount of calculation using a DCT coefficient is proposed.

### DISCLOSURE

### Technical Problem

Embodiments of the inventive concepts provide a method, an apparatus, and a system for sensing whether an event for a digital image occurs, using a plurality of frequency components of the digital image.

Embodiments of the inventive concepts provide a method, an apparatus, and a system for sensing whether an event occurs in a digital image by using a direct current (DC) component value of a frequency component in a process of sensing whether the event for the digital image occurs.

Embodiments of the inventive concepts provide a method, an apparatus, and a system for sensing whether an ambient lighting change occurs in a digital image by using a DC component value and an alternating current (AC) component value in a process of sensing whether the event occurs in the digital image.

Embodiments of the inventive concepts provide a method, an apparatus, and a system for sensing whether an object change occurs in a digital image by sensing whether an ambient lighting change occurs in the digital image.

Embodiments of the inventive concepts provide a method, an apparatus, and a system for using DCT coefficients which are a plurality of frequency components of a digital image.

### Technical Solution

One aspect of embodiments of the inventive concept is directed to provide an event sensing method using a frequency component in a surveillance camera. The method may include obtaining at least one of a plurality of frequency components for a first frame of a digital image and at least one of a plurality of frequency components for a second frame subsequent to the first frame of the digital image and sensing whether an event occurs in a digital image corresponding to the second frame using the at least one of the plurality of frequency components for the first frame and the at least one of the plurality of frequency components for the second frame.

The sensing of whether the event occurs may include sensing a change between a direct current (DC) component value among the plurality of frequency components for the first frame and a DC component value among the plurality of frequency components for the second frame.

The sensing of the change between the change between the DC component value among the plurality of frequency components for the first frame and the DC component value among the plurality of frequency components for the second frame may include comparing a change amount between the DC component value among the plurality of frequency components for the first frame and the DC component value among the plurality of frequency components for the second frame with a first threshold. The first threshold may be determined based on the DC component value among the plurality of frequency components for the first frame.

The sensing of whether the event occurs may include determining whether the plurality of frequency components for the second frame are changed at a ratio with respect to the plurality of frequency components for the first frame and sensing whether an ambient lighting change occurs in the digital image corresponding to the second frame based on the determined result.

The determining of whether the plurality of frequency components for the second frame are changed at the ratio with respect to the plurality of frequency components for the first frame may include comparing a difference between a formula associated with a DC component value and an alternating current (AC) component value among the plurality of frequency components for the first frame and a formula associated with a DC component value and an AC component value among the plurality of frequency components for the second frame with a second threshold.

The sensing of whether the event occurs may further include encoding the digital image corresponding to the second frame based on a video image compression scheme using a high-compression encoder, if the event occurs in the digital image corresponding to the second frame.

The encoding of the digital image corresponding to the second frame based on the video image compression scheme may include storing the encoded digital image corresponding to the second frame.

The sensing of whether the event occurs in the digital image corresponding to the second frame may include sensing whether the event occurs in the digital image corresponding to the second frame using the at least one of the plurality of frequency components for the first frame and the at least one of the plurality of frequency components for the second frame, over the entire region of the digital image.

The method may further include obtaining a plurality of frequency components of a frequency domain from a digital image of a pixel domain using a low-power encoder. The plurality of frequency components may be discrete cosine transform (DC) coefficients.

Another aspect of embodiments of the inventive concept is directed to provide an event sensing system using a frequency component in a surveillance camera. The system may include an obtaining unit configured to obtain at least one of a plurality of frequency components for a first frame of a digital image and at least one of a plurality of frequency components for a second frame subsequent to the first frame of the digital image and a sensing unit configured to sense whether an event occurs in a digital image corresponding to the second frame using the at least one of the plurality of frequency components for the first frame and the at least one of the plurality of frequency components for the second frame.

The sensing unit may sense a change between a DC component value among the plurality of frequency components for the first frame and a DC component value among the plurality of frequency components for the second frame.

The sensing unit may compare a change amount between the DC component value among the plurality of frequency components for the first frame and the DC component value among the plurality of frequency components for the second frame with a first threshold.

The sensing unit may determine whether the plurality of frequency components for the second frame are changed at a ratio with respect to the plurality of frequency components for the first frame and may sense whether an ambient lighting change occurs in the digital image corresponding to the second frame based on the determined result.

The sensing unit may compare a difference between a formula associated with a DC component value and an AC component value among the plurality of frequency components for the first frame and a formula associated with a DC component value and an AC component value among the plurality of frequency components for the second frame with a second threshold.

### Advantageous Effects

According to various embodiments, an event sensing system may sense whether an event for a digital image occurs, using a plurality of frequency components of the digital image.

According to various embodiments, the event sensing system may sense whether an event occurs in a digital image by using a DC component value of a frequency component in a process of sensing whether the event for the digital image occurs.

According to various embodiments, the event sensing system may reduce an amount of comparison calculation compared with sampling all pixel values in a conventional SD scheme by sensing whether an event occurs by comparing DC coefficients.

According to various embodiments, the event sensing system may sense whether an ambient lighting change occurs in a digital image by using a DC component value and an AC component value in a process of sensing whether the event occurs in the digital image.

According to various embodiments, the event sensing system may reduce an error sensing rate by using an AC component value as well as a DC component value.

According to various embodiments, the event sensing system may adaptively adjust importance between accuracy of a recognition rate and energy consumption by adjusting the number of used AC component values in a process of using a DC component value and an AC component value.

According to various embodiments, the event sensing system may sense whether an object change occurs in a digital image by sensing whether an ambient lighting change occurs in the digital image.

According to various embodiments, the event sensing system may use DCT coefficients which are a plurality of frequency components of a digital image.

### DESCRIPTION OF DRAWINGS

FIG. 1 is a block diagram illustrating an event sensing system using a frequency component in a surveillance camera according to an embodiment of the inventive concept;

FIG. 2 is a flowchart illustrating an event sensing method using a frequency component in a surveillance camera according to an embodiment of the inventive concept;

FIG. 3 is a flowchart illustrating in detail a process of sensing whether an event occurs, shown in FIG. 2 according to an embodiment of the inventive concept;

FIGS. 4A and 4B are drawings illustrating a method for sensing an object change in a digital image having high and low DC component values according an embodiment of the inventive concept;

FIG. 5 is a drawing illustrating a method for determining the number of used frequency components in a process of sensing an event, according an embodiment of the inventive concept;

FIGS. 6A and 6B are drawings illustrating an 8×8 region for a test of determining the number of used frequency components in a process of sensing an event, according an embodiment of the inventive concept;

FIG. 7 is a graph illustrating a false positive (FP) occurrence percentage based on an imbalance in lighting, according an embodiment of the inventive concept;

FIG. 8 is a graph illustrating a lighting imbalance distribution rate according an embodiment of the inventive concept; and

FIG. 9 is a block diagram illustrating an event sensing system using a frequency component in a surveillance camera according an embodiment of the inventive concept.

### BEST MODE

Hereinafter, a description will be given in detail of embodiments with reference to the accompanying drawings. However, the inventive concept is not limited to the disclosed embodiments. Also, like reference numerals denote like elements throughout the attached drawings and written description.

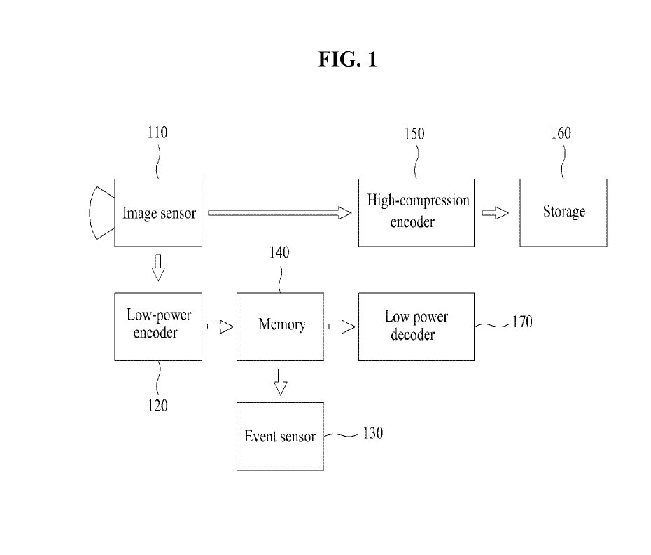

FIG. 1 is a block diagram illustrating an event sensing system using a frequency component in a surveillance camera according to an embodiment of the inventive concept.

Referring to FIG. 1, the event sensing system according to an embodiment of the inventive concept may include an image sensor 110 for receiving an optical signal and generating a digital image, a low-power encoder 120 and an event sensor 130 for converting a digital image of a pixel domain received from the image sensor 110 into a plurality of frequency components in a frequency domain, a memory 140 for storing the plurality of frequency components, converted from the digital image of the pixel domain, on a frame-by-frame basis, a high-compression encoder 150 for encoding a digital image in which an event occurs, based on a predetermine video image compression scheme, and a storage 160 for storing the digital image encoded based on the predetermined video image compression scheme. In addition, the event sensing system may further include a low-power decoder 170.

Herein, although not illustrated, the event sensor 130 may include an obtaining unit for obtaining at least one of a plurality of frequency components for a first frame of a digital image and at least one of a plurality of frequency components for a second frame subsequent to the first frame of the digital image and a sensing unit for sensing whether an event occurs in a digital image corresponding to the second frame using at least the one of the plurality of frequency components for the first frame and the at least one of the plurality of frequency components for the second frame. As such, the obtaining unit and the sensing unit included in the event sensor 130 may be arranged to be independent of each other. As the event sensor 130 performs the functions performed by the obtaining unit and the sensing unit, the obtaining and the sensing unit may be configured as one device.

The low-power encoder 120 may convert the digital image of the pixel domain into the plurality of frequency components in the frequency domain. Herein, the low-power encoder 120 may be a low-power encoder which converts the digital image of the pixel domain into a discrete cosine transform (DCT) region. For example, the low-power encoder 120 may represent the digital image of the pixel domain as the plurality of frequency components of the frequency domain by encoding the digital image of the pixel domain based on a predetermined still image compression scheme such as a joint photographic coding experts group (JPEG) scheme. The JPEG scheme may be used as a technique for obtaining a plurality of frequency components from a digital image of a pixel domain in a process of sensing an event according to an embodiment of the inventive concept. Embodiments of the inventive concept are not limited thereto. For example, another conversion technique for converting a digital image of a pixel domain into a frequency domain having a plurality of frequency components may be used. For example, a transform technique such as a two-dimensional (2D) wavelet transform may be used as the technique for obtaining the plurality of frequency components from the digital image of the pixel domain in the process of sensing the event.

The high-compression encoder 150 may encode a digital image corresponding to a frame in which an event occurs, based on a predetermined video image compression scheme such as an H.264 scheme. In this case, the high-compression encoder 150 may encode the digital image corresponding to the frame in which the event occurs, by directly receiving the digital image corresponding to the frame in which the event occurs from the image sensor 110 or receiving a decoded digital image of the frame in which the event occurs, after a digital image of a frequency domain of the frame in which the event occurs is decoded.

The event sensing system according to an embodiment of the inventive concept may usually store a digital image on a frame-by-frame basis in the memory 140 using the low-power encoder 120. The event sensing system may sense whether an event occurs in a digital image on a frame-by-frame basis, stored in the memory 140 using the event sensor 130. If the event occurs, the event sensing system may encode only a digital image corresponding to a frame in which the event occurs, using the high-compression encoder 150 and may store the encoded digital image in the storage 160. Therefore, the event sensing system may minimize energy consumed in the process of sensing the event and capacity of storing a file which is the digital image in which the event occurs. In this case, power consumed based on the JPEG scheme and the H.264 scheme and capacity of a file generated based on the JPEG scheme and the H.264 scheme are shown in Table 1 below relative to an image of full high definition (FHD) and an image of 30 frames per second (fps).

TABLE 1

| | H.264 | JPEG |
|---|---|---|
| Power consumption (mw) | 538 | 116 |
| File capacity | 0.89 | 2.9 |

The event sensing system according to an embodiment of the inventive concept may use a plurality of frequency components by converting a digital image of a pixel domain into a frequency domain configured with a plurality of frequency components using the JPEG scheme. Hereinafter, the plurality of frequency components of the digital image may refer to a plurality of DCT coefficients of a digital image encoded by the JPEG scheme. Therefore, the event sensing system may use a DCT coefficient without additional DCT calculation.

A method for sensing an event using a DCT coefficient of a digital image will be described in detail below.

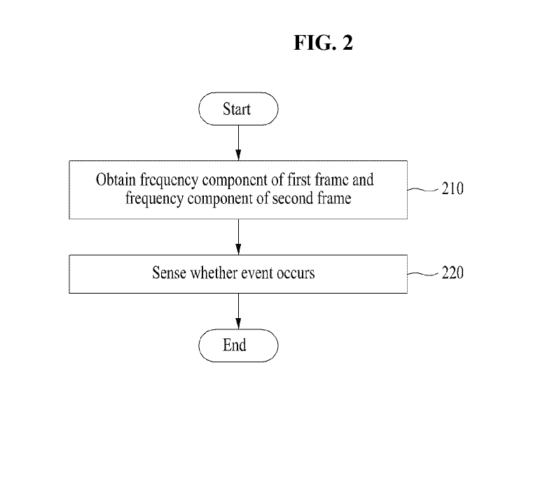

FIG. 2 is a flowchart illustrating an event sensing method using a frequency component in a surveillance camera according to an embodiment of the inventive concept.

Referring to FIG. 2, in step 210, an event sensing system according to an embodiment of the inventive concept may obtain at least one of a plurality of frequency components for a first frame of a digital image and at least one of a plurality of frequency components for a second frame subsequent to the first frame of the digital image.

In this case, although not illustrated, the event sensing system may obtain a plurality of frequency components of a frequency domain from a digital image of a pixel domain using its low-power encoder. For example, the low-power encoder may convert the digital image of the pixel domain received from an image sensor of the event sensing system into the plurality of frequency domains in the frame domain. Therefore, the event sensing system may obtain the plurality of frequency components.

Next, in step 220, the event sensing system may sense whether an event occurs in a digital image corresponding to the second frame using the at least one of the plurality of frequency components for the first frame and the at least one of the plurality of frequency components for the second frame.

Herein, the plurality of frequency components may refer to DCT coefficients. As such, the reason to use the DCT coefficients is because an amount of calculation may be minimized, since additional DC calculation is not needed as a digital image of a pixel domain is converted into a frequency domain by a JPEG scheme. Also, the reason is because an event may be sensed by selecting and using only a few DCT coefficients, since most information of a digital image is stored in a low frequency component of a DCT coefficient.

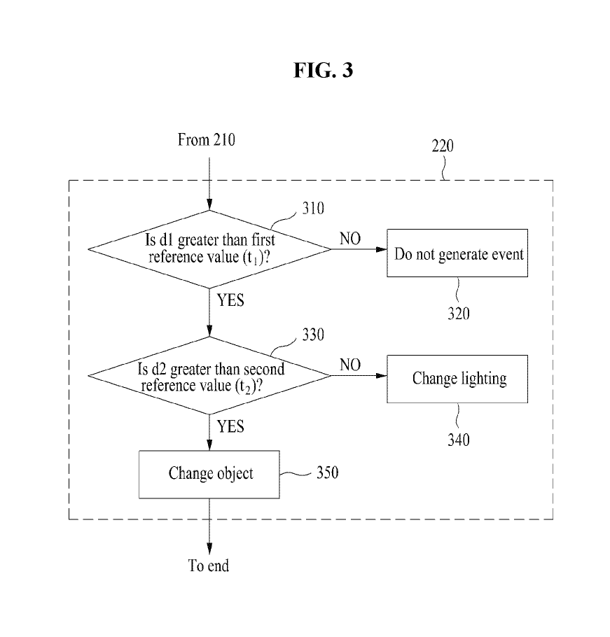

The event sensing system may further reduce an amount of calculation by dividing step 220 of sensing whether the event occurs in the digital image corresponding to the second frame into two steps and performing the two steps. Also, to prevent an event from being incorrectly sensed due to an ambient lighting change in a digital image, the event sensing system may accurately sense a lighting change and an object change. A detailed description will be given for this with reference to FIG. 3.

FIG. 3 is a flowchart illustrating in detail a process of sensing whether an event occurs, shown in FIG. 2 according to an embodiment of the inventive concept.

Referring to FIG. 3, an event sensing system according to an embodiment of the inventive concept may sense a change between a direct current (DC) component value among a plurality of frequency components for a first frame and a DC component value among a plurality of frequency components for a second frame. In this case, in step 310, the event sensing system may sense the change between the DC component value of the first frame and the DC component value of the second frame by comparing a change amount between the DC component value among the plurality of frequency components for the first frame and the DC component value among the plurality of frequency components for the second frame with a predetermined first reference value T₁ (or a predetermined first threshold T₁).

For example, if the change amount between the DC component value of the second frame and the DC component value of the first frame is less than or equal to the predetermined first threshold T₁ like Equation 1 below, in step 320, the event sensing system may sense that an event does not occur in a digital image corresponding to the second frame. Meanwhile, if the change amount between the DC component value of the second frame and the DC component value of the first frame is greater than the predetermined first threshold T₁, the event sensing system may sense that the event occurs in the digital image corresponding to the second frame.

D1=|Xₜ(0.0)−Xₜ₋₁(0,0)|>T₁ [Equation 1]

Herein, t may represent a frame number. Xₜ(k₁,k₂) may represent a DCT coefficient. Also, when k₁ and k₂ are more increased, lateral and longitudinal components of a frequency component may be more increased. Therefore, a DC component value may refer to a frequency component if each of the lateral and longitudinal components of the frequency component is ‘0’, that is, a DCT coefficient. Also, T₁ may be a predetermined first threshold and may be set to be adaptively changed by statistics.

Also, the predetermined first threshold T₁ may be determined based on the DC component value among the plurality of frequency components for the first frame. Therefore, the event sensing system according to an embodiment of the inventive concept may sense that the event does not occur in the digital image corresponding to the second frame using a ratio between the DC component value of the first frame and the change amount between the DC component value of the second frame and the DC component value of the first frame.

The event sensing system may sense that an event locally occurs in the digital image by repeatedly performing the process of sensing the change between the DC component value among the plurality of frequency components for the first frame and the DC component value among the plurality of frequency components for the second frame over the entire region of the digital image.

Next, if sensing the change between the DC component value of the first frame and the DC component of the second frame, the event sensing system may recognize that at least one of a lighting image or an object change occurs in the digital image corresponding to the second frame and may determine whether the corresponding change is one of the lighting change or the object change. In this case, if the lighting change occurs in the digital image corresponding to the second frame, the event sensing system may use properties in which the plurality of frequency components for the second frame are changed at a certain ratio with respect to the plurality of frequency components for the first frame. Properties in which the plurality of frequency components are changed based on the lighting change will be described in detail hereinafter.

If an ambient lighting change occurs in a digital image, a pixel value of a frame before the lighting change occurs and a pixel value of a frame after the lighting change occurs may have a certain ratio. If the certain ratio is applied to a DCT coefficient, Equation 2 may be drawn.

Xₜ=AxₜA^{T}=Aαxₜ₋₁A^{T}=αXₜ₋₁ [Equation 2]

(Xₜ=AxₜA^{T}=Aαx₍ₜ₋₁₎A^{T}=Ax₍ₜ₋₁₎)

Herein, X may represent an 8×8 matrix of DCT coefficients. x may represent an 8×8 matrix of pixel values of a spatial domain. A may represent a DCT matrix. A^{T} may represent a transposed matrix of A. Therefore, if a lighting change occurs in one of two subsequent frames from Equation 2, it may be seen that a plurality of frequency components of a frame before the lighting change occurs and a plurality of frequency components of a frame after the lighting change occurs are changed at a certain rate. Meanwhile, if the plurality of frequency components of each of the previous frame and the subsequent frame between the two subsequent frames are not changed at the certain ratio, it may be seen that an object change rather than the lighting change occurs in the subsequent frame. For example, if an object change occurs in one of the two subsequent frames, each of a plurality of frequency components of a frame before the object change occurs and each of a plurality of frequency components of a frame after the object change occurs may be changed at another ratio for each frequency component (k₁, k₂).

Therefore, the event sensing system may determine whether the plurality of frequency components for the second frame are changed at a certain ratio with respect to the plurality of frequency components for the first frame and may sense whether an ambient lighting change occurs the digital image corresponding to the second frame based on the determined result. In this case, in step 330, the event sensing system may determine whether the plurality of frequency components of the second frame are changed at the certain ratio with respect to the plurality of frequency components of the first frame by comparing a difference between a formula associated with a DC component value and an alternating current (AC) component value among the plurality of frequency components for the first frame and a formula associated with a DC component value and an AC component value among the plurality of frequency components for the second frame with a predetermined second threshold T₂.

For example, if the difference between the formula associated with the DC component value and the AC component value among the plurality of frequency components for the first frame and the formula associated with the DC component value and the AC component value among the plurality of frequency components for the second frame is less than or equal to the predetermined second threshold T₂, in step 340, the event sensing system may sense that an ambient lighting change occurs in the digital image corresponding to the second frame.

Meanwhile, if the difference between the formula associated with the DC component value and the AC component value among the plurality of frequency components for the first frame and the formula associated with the DC component value and the AC component value among the plurality of frequency components for the second frame is greater than the predetermined second threshold T₂, in step 350, the event sensing system may sense that an object change occurs in the digital image corresponding to the second frame.

$$D 2 ( {k}_{1} , {k}_{2} ) = \vert \frac{{X}_{t} ( {k}_{1} , {k}_{2} )}{{X}_{t} ( 0 , 0 )} - \frac{{X}_{t - 1} ( {k}_{1} , {k}_{2} )}{{X}_{t - 1} ( 0.0 )} \vert > {T}_{2} , 0 \leq ( {k}_{1} , {k}_{2} ) < N , \\ where ( {k}_{1} , {k}_{2} ) = ( 0 , 0 ) is excepted \qquad [ Equation 3 ]$$

Herein, t may represent a frame number. Xₜ(k₁,k₂) may represent a DCT coefficient of the second frame. Also, when k₁ and k₂ are more increased, lateral and longitudinal components of a frequency component may be more increased. Therefore, a DCT component value may represent a frequency component if each of the lateral and longitudinal components of the frequency component is ‘0’, that is, a DCT coefficient. An AC component value may represent a frequency component if each of the lateral and longitudinal components of the frequency component is not ‘0’, that is, a DC coefficient. Also, T₂ may be the predetermined second threshold and may be set to be adaptively changed by statistics. In this case, most of DC values of each of the first frame and the second frame may have a value of ‘200’ or more, whereas most of AC component values of each of the first frame and the second frame may have a value near ‘0’. Therefore, if the AC components of each of the first frame and the second frame are used as a denominator in Equation 3, a noise such as an error of a shading model and a false positive (FP) may occur. Therefore, the DC component values of each of the first frame and the second frame may be used as a denominator like Equation 3.

If an event such as the object change occurs in the digital image corresponding to the second frame through the above-mentioned process, although not illustrated, the event sensing system may encode the digital image corresponding to the second frame based on a predetermined video image compression scheme using a high-compression encoder. Also, the event sensing system may store the digital image corresponding to the second frame, encoded based on the predetermined video image compression scheme. In this case, the event sensing system may integrate a digital image corresponding to the first frame and the digital image corresponding to the second frame, encoded based on the predetermined video image compression scheme, into one file as a file associated with occurrence of the event and may store the file.

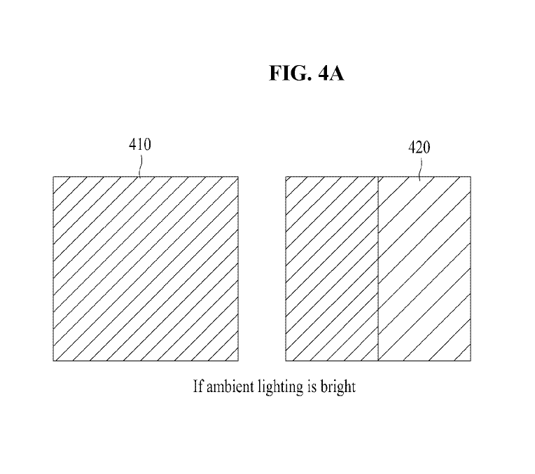

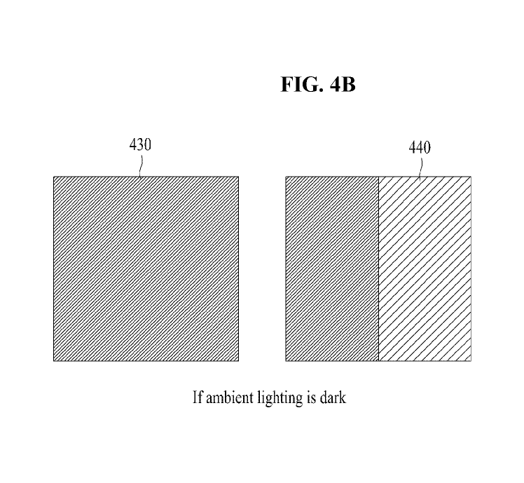

FIGS. 4A and 4B are drawings illustrating a method for sensing an object change in a digital image having high and low DC component values according an embodiment of the inventive concept.

Referring to FIGS. 4A and 4B, if an event sensing system according an embodiment of the inventive concept senses an object change in a digital image corresponding to a second frame using Equation 3 above, a false negative (FN) may occur when a DC component value is very high.

For example, a difference D2 between a formula associated with a DC component value and an AC component value for a first frame 410 of a digital image if ambient lighting is bright and a formula associated with a DC component value and an AC component value for a second frame 420 of the digital image in which there is an object if the ambient lighting is dark and a difference D2 between a formula associated with a DC component value and an AC component value for a first frame 430 of a digital image if ambient lighting is dark and a formula associated with a DC component value and an AC component value for a second frame 440 of the digital image in which there is an object if the ambient lighting is dark are shown in Table 2 below.

TABLE 2

| | If ambient lighting is bright | If ambient lighting is dark |
|---|---|---|
| D2(1, 0) | 0.063 | 0.305 |

As shown in Table 2, D2 if the ambient lighting is bright may be a smaller value and may be less than a predetermined second threshold T₂. Therefore, as D2 is represented like Equation 4 below derived from Equation 3 above, the event sensing system may efficiently sense an object change in a digital image having high and low DC components.

$$\begin{matrix} D 2 ( {k}_{1} , {k}_{2} ) = \vert \frac{{X}_{t} ( {k}_{1} , {k}_{2} )}{{X}_{t} ( 0 , 0 )} - \frac{{X}_{t - 1} ( {k}_{1} , {k}_{2} )}{{X}_{t - 1} ( 0 , 0 )} \vert * {X}_{t - 1} ( 0 , 0 ) \\ = \vert γ {X}_{t} ( {k}_{1} , {k}_{2} ) - {X}_{t - 1} ( {k}_{1} , {k}_{2} ) \vert > {T}_{3} ,\end{matrix} \\ γ = \frac{{X}_{t - 1} ( 0 , 0 )}{{X}_{t} ( 0 , 0 )} \\ D 2 ( {k}_{1} , {k}_{2} ) = \vert ( {X}_{t} ( {k}_{1} , {k}_{2} ) ) / ( {X}_{t} ( 0 , 0 ) ) - ( {X}_{( t - 1 )} ( {k}_{1} , {k}_{2} ) ) / ( {X}_{( t - 1 )} ( 0 , 0 ) ) \vert * {X}_{( t - 1 )} ( 0 , 0 ) = \vert γ {X}_{t} ( {k}_{1} , {k}_{2} ) - {X}_{( t - 1 )} ( {k}_{1} , {k}_{2} ) \vert > {T}_{3} , \\ γ = ( {X}_{( t - 1 )} ( 0 , 0 ) ) / ( {X}_{t} ( 0 , 0 ) ) \qquad [ Equation 4 ]$$

Herein, T₃ may be a predetermined second threshold and may be set to a value different from the predetermined second threshold T₂ shown in Equation 3 above. D2 calculated based on Equation 4 above are shown in Table 3 below.

TABLE 3

| | If ambient lighting is bright | If ambient lighting is dark |
|---|---|---|
| D2(1, 0) | 101.144 | 72.487 |

As such, the event sensing system according to an embodiment of the inventive concept may calculate D2 using Equation 4 above. In this case, if y is calculated once, since the calculated y is used in several (k₁,k₂) components, an amount of calculation necessary for D2 may be reduced.

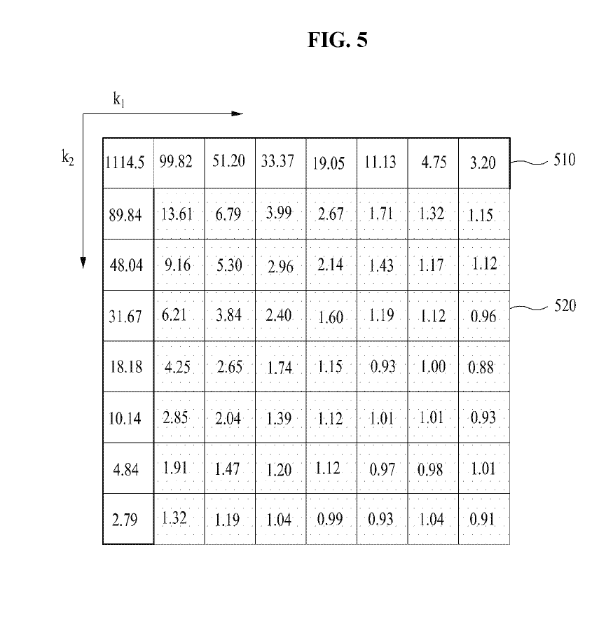

FIG. 5 is a drawing illustrating a method for determining the number of used frequency components in a process of sensing an event, according an embodiment of the inventive concept.

An event sensing system according to an embodiment of the inventive concept may determine whether a plurality of frequency components for a second frame are changed at a certain rate with respect to a plurality of frequency components for a first frame. Herein, the event sensing system may select some of the plurality of frequency components for the second frame and may determine whether to compare the selected frequency components with the frequency components of the first frame.

Referring to FIG. 5, since an object is simpler than a background in a digital image where an object change occurs, there is barely a checked pattern in an 8×8 region. Therefore, when an object change occurs, frequency components 510 having higher values are easy to sense an object, and frequency components 520 having lowers value may be hard to sense an object. Therefore, the event sensing system according to an embodiment of the inventive concept may select the other frequency components 510 except for the frequency components 520 having the lower value in a digital image having an 8×8 region. In this case, the other frequency components 510 may be components having frequencies in one direction.

Frequency components selected to sense an object change among the other frequency components 510 by the event sensing system and the number of the selected frequency components are shown in Table 4 below.

TABLE 4

| P | (k₁, k₂) used in Equation 4 above |
|---|---|
| 1 | (1, 0), (0, 1) |
| 2 | (1, 0), (2, 0), (0, 1), (0, 2) |
| 3 | (1, 0), (2, 0), (4, 0), (0, 1), (0, 2), (0, 4) |
| 4 | (1, 0), (2, 0), (3, 0), (4, 0), (0, 1), (0, 2), (0, 3), (0, 4) |

Herein, p may indicate how many frequency components are horizontally or vertically selected.

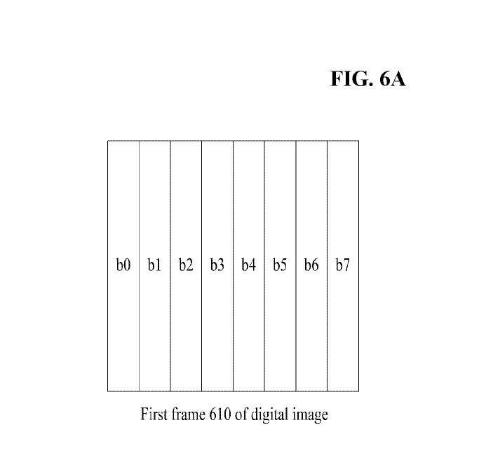

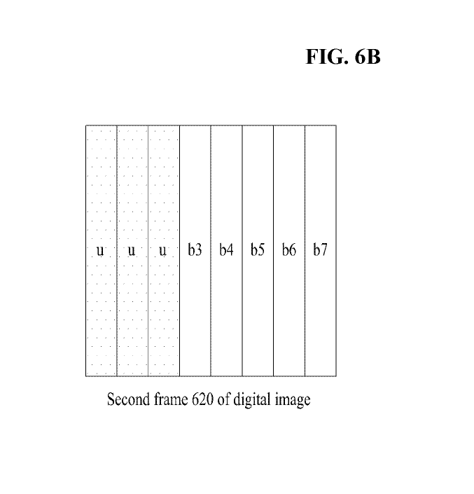

FIGS. 6A and 6B are drawings illustrating an 8×8 area for a test of determining the number of used frequency components in a process of sensing an event, according an embodiment of the inventive concept.

Referring to FIGS. 6A and 6B, in a digital image corresponding to a first frame 610 before an object is changed, the object may be displayed on a region corresponding to three left blanks in a second frame 620. Herein, b0 to b7 may represent background pixel values in the digital image, and u may represent a pixel value of the object.

In this case, D2 is calculated using Equation 5 below.

$$D 2 ( 1 , 0 ) = \vert \frac{{x}_{t} A ( \text{:} , 1 )}{{x}_{t} A ( \text{:} , 0 )} - \frac{{x}_{t - 1} A ( \text{:} , 1 )}{{x}_{t - 1} A ( \text{:} , 0 )} \vert * {x}_{t - 1} A ( \text{:} , 0 ) > {T}_{4} , \\ \{ D 2 ( 1 , 0 ) = \vert ( {x}_{t} A ( \text{:} , 1 ) ) / ( {x}_{t} A ( \text{:} , 0 ) ) - ( {x}_{( t - 1 )} A ( \text{:} , 1 ) ) / ( {x}_{( t - 1 )} A ( \text{:} , 0 ) ) \vert {}_{}^{*}{x}{}_{( t - 1 )}^{} A ( \text{:} , 0 ) > {T}_{4} , \} \qquad [ Equation 5 ]$$

In Equation 5, T₄ may represent a predetermined second threshold. x₍ₜ₋₁₎=(b0 b1 b2 b3 b7), xₜ=(u u u b3 b4 b7) may represent a 1D matrix of a spatial domain. A may represent a 1D DCT matrix. A frequency component may be changed based on how many volumes are multiplied. For example, if A(:,0) is multiplied by xₜ, there may be X(0,0). Since b0 to b7 are background pixel values, they are constants. Since values in the A matrix are fixed, Equation 5 may be a simple equation for u. Therefore, Equation 5 may represent a range of pixel values of an object which may be sensed. In this case, the range of the pixel values of the object which may be sensed may be determined by the background pixel values b0 to b7, the number of blanks occupied by the object, a value of p and T₄.

Therefore, an FN rate based on p and T₄ are shown in Table 5 below. Herein, background pixel values are simplified as 1,128 and 256.

TABLE 5

| | T₄ p | | | | |
|---|---|---|---|---|---|
| | 10 | 40 | 70 | 700 | 130 |
| 1 | 2.98 | 11.73 | 20.06 | 28.18 | 36.04 |
| 2 | 0.53 | 2.35 | 4.06 | 6.41 | 10.01 |
| 3 | 0.23 | 0.98 | 1.68 | 2.6 | 6.10 |
| 4 | 0.19 | 0.83 | 1.47 | 2.32 | 5.31 |
| 5 | 0.14 | 0.6 | 1.11 | 1.84 | 4.15 |
| 6 | 0.07 | 0.3 | 0.56 | 1.08 | 2.32 |
| 7 | 0.05 | 0.19 | 0.37 | 0.74 | 1.66 |

The FN rate of Table 5 may refer to ‘(a range of u which fails in sensing)/256*100’. 6561 backgrounds and 8 blanks occupied by an object are averaged. When the FN rate is more reduced, it is better. Therefore, the event sensing system according to an embodiment of the inventive concept may determine the number of used frequency components as displayed in bold font of Table 5 in a process of sensing an event. If displayed in bold font in Table 5, there may be the least amount of calculation for sensing an object change.

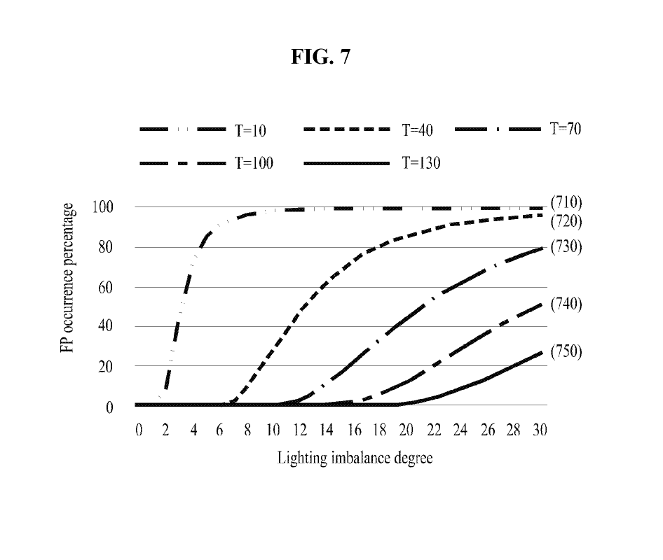

FIG. 7 is a graph illustrating an FP occurrence percentage based on an imbalance in lighting, according an embodiment of the inventive concept.

Referring to FIG. 7, an event sensing system according to an embodiment of the inventive concept may determine a predetermined second threshold.

Herein, if there is lighting imbalance in an 8×8 region, it may be misrecognized as an object. When a predetermined second threshold T₄ is larger, an FP rate generated by the lighting imbalance may be more reduced. For example, seeing an FP rate 710 if T₄ is 10, an FP rate 720 if T₄ is 40, an FP rate 730 if T₄ is 70, an FP rate 740 if T₄ is 100, and an FP rate 750 if T₄ is 130, it may be seen that the FP rate if T₄ is 130 is the lowest rate.

Therefore, the event sensing system may reduce an FP rate by determining the predetermined second threshold T₄ as a larger value.

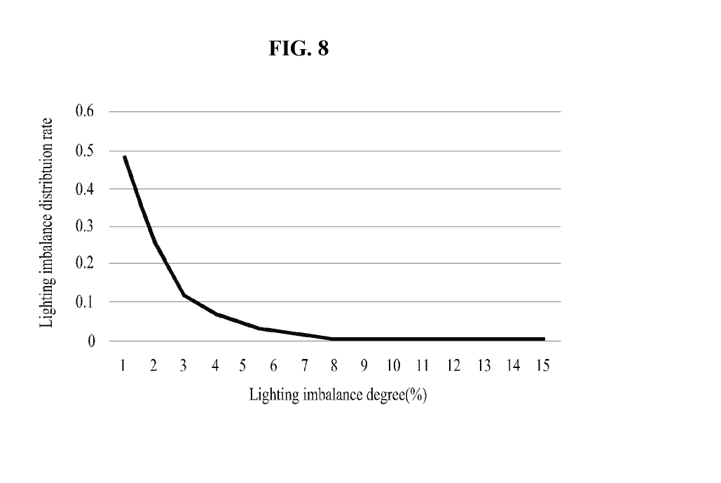

FIG. 8 is a graph illustrating a lighting imbalance distribution rate according an embodiment of the inventive concept. In this case, how much stronger a place with the strongest lighting is than a place with the weakest lighting in an 8×8 region may be indicated by a percentage.

Referring to FIG. 8, in a digital image having natural light, artificial light, or lighting by a headlight of a vehicle, most of lighting imbalance degrees in the 8×8 region are 15% or less. Therefore, if the predetermined second threshold T₄ is determined as 100, most of FPs by imbalanced lighting may be removed.

Thus, an event sensing system according to an embodiment of the inventive concept may sense whether an object change occurs by horizontally or vertically selecting three frequency components among a plurality of frequency components for a second frame and determining the predetermined second threshold as 100.

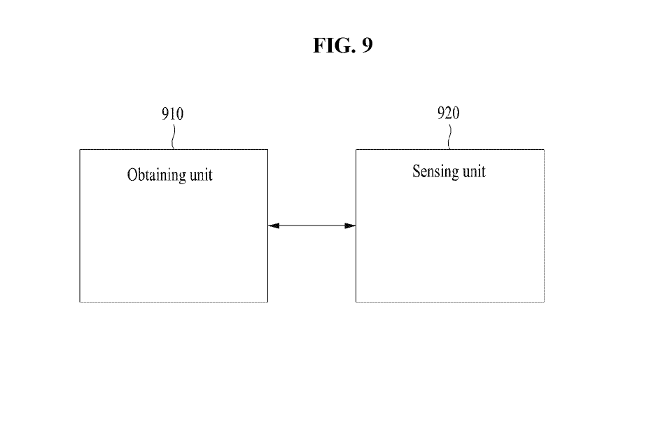

FIG. 9 is a block diagram illustrating an event sensing system using a frequency component in a surveillance camera according an embodiment of the inventive concept.

Referring to FIG. 9, the event sensing system according to an embodiment of the inventive concept may include an obtaining unit 910 and a sensing unit 920.

The obtaining unit 910 may obtain at least one of a plurality of frequency components for a first frame of a digital image and at least one of a plurality of frequency components for a second frame subsequent to the first frame of the digital image.

In this case, although not illustrated, the event sensing system may further include a low-power encoder for obtaining a plurality of frequency components of a frequency domain from a digital image of a pixel domain. For example, the low-power encoder may convert the digital image of the pixel domain into the plurality of frequency components in the frequency domain. In detail, the low-power encoder may be a low-power encoder for converting the digital image of the pixel domain into a DCT region.

Also, although not illustrated, the event sensing system may further include an image sensor. The low-power encoder may use a digital image generated from the image sensor.

Also, although not illustrated, the event sensing system may further include a memory for a plurality of frequency components of a frequency domain corresponding to the digital image of the pixel domain, converted by the low-power encoder.

The sensing unit 920 may sense whether an event occurs in a digital image corresponding to the second frame using the at least one of the plurality of frequency components for the first frame and the at least one of the plurality of frequency components for the second frame.

Herein, the plurality of frequency components may refer to DCT coefficients. As such, the reason to use the DCT coefficients is because an amount of calculation may be minimized, since additional DC calculation is not needed as a digital image of a pixel domain is converted into a frequency domain by a JPEG scheme. Also, the reason is because an event may be sensed by selecting and using only a few DCT coefficients, since most information of a digital image is stored in a low frequency component of a DCT coefficient.

Also, the sensing unit 920 may sense a change between a DC component value among the plurality of frequency components for the first frame and a DC component value among the plurality of frequency components for the second frame.

In this case, the sensing unit 920 may sense the change between the DC component value among the plurality of frequency components for the first frame and the DC component value among the plurality of frequency components for the second frame by comparing a change amount between the DC component value among the plurality of frequency components for the first frame and the DC component value among the plurality of frequency components for the second frame with a predetermined first threshold. Herein, the predetermined first threshold may be determined based on the DC component value among the plurality of frequency components for the first frame.

For example, if the change amount between the DC component value of the second frame and the DC component value of the first frame is less than or equal to the predetermined first threshold like Equation 1 above, the sensing unit 920 may sense that an event does not occur in a digital image corresponding to the second frame. Meanwhile, if the change amount between the DC component value of the second frame and the DC component value of the first frame is greater than the predetermined first threshold, the sensing unit 920 may sense that the event occurs in the digital image corresponding to the second frame.

Also, the sensing unit 920 may sense that an event locally occurs in a digital image by repeatedly performing the process of sensing the change between the DC component value among the plurality of frequency components for the first frame and the DC component value among the plurality of frequency components for the second frame over the entire region of the digital image.

Also, the sensing unit 920 may determine whether the plurality of frequency components for the second frame are changed at a certain ratio with respect to the plurality of frequency components for the first frame and may sense whether an ambient lighting change occurs in the digital image corresponding to the second frame based on the determined result.

In this case, the sensing unit 920 may determine whether the plurality of frequency components for the second frame are changed at a certain ratio with respect to the plurality of frequency components for the first frame by comparing a difference associated with a formula associated with a DC component value and an AC component value among the plurality of frequency components for the first frame and a formula associated with a DC component value and an AC component value among the plurality of frequency components for the second frame with a predetermined second threshold.

For example, if the difference between the formula associated with the DC component value and the AC component value among the plurality of frequency components for the first frame and the formula associated with the DC component value and the AC component value among the plurality of frequency components for the second frame is less than or equal to the predetermined second threshold, the sensing unit 920 may sense that an ambient lighting change occurs in the digital image corresponding to the second frame. Meanwhile, if the difference between the formula associated with the DC component value and the AC component value among the plurality of frequency components for the first frame and the formula associated with the DC component value and the AC component value among the plurality of frequency components for the second frame is greater than the predetermined second threshold, the sensing unit 920 may sense that an object change occurs in the digital image corresponding to the second frame.

The obtaining unit 910 and the sensing unit 920 may be configured to be independent of each other or may be configured as one equipment.

Also, although not illustrated, the event sensing system may further include a high-compression encoder for encoding the digital image corresponding to the second frame based on a predetermined video image compression scheme if an event such as an object change occurs in the digital image corresponding to the second frame. In this case, the event sensing system may further include a low-power encoder. The high-compression encoder may encode a digital image corresponding to a second frame in which an event occurs, based on the predetermined video image compression scheme by receiving a digital image in which a digital image of a frequency domain corresponding to the second frame is decoded, from the high-compression encoder.

Also, although not illustrated, the event sensing system may further include a storage for storing the digital image corresponding to the second frame, encoded based on the predetermined video image compression scheme by the high-compression encoder. In this case, a digital image corresponding to the first frame before an event occurs and the digital image corresponding to the second frame, encoded based on the predetermined video image compression scheme, may be integrated into one file, and the one file may be stored in the storage.

### MODE FOR INVENTION

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described exemplary embodiments of the inventive concept may be recorded in computer-readable media including program instructions to implement various operations embodied by a computer. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Program instructions include both machine code, such as produced by a compiler, and files containing higher level code that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

1. An event sensing method using a frequency component in a surveillance camera, the method comprising:
obtaining at least one of a plurality of frequency components for a first frame of a digital image and at least one of a plurality of frequency components for a second frame subsequent to the first frame of the digital image; and
sensing whether an event occurs in a digital image corresponding to the second frame using the at least one of the plurality of frequency components for the first frame and the at least one of the plurality of frequency components for the second frame.

2. The method of claim 1, wherein the sensing of whether the event occurs comprises:
sensing a change between a direct current (DC) component value among the plurality of frequency components for the first frame and a DC component value among the plurality of frequency components for the second frame.

3. The method of claim 2, wherein the sensing of the change between the change between the DC component value among the plurality of frequency components for the first frame and the DC component value among the plurality of frequency components for the second frame comprises:
comparing a change amount between the DC component value among the plurality of frequency components for the first frame and the DC component value among the plurality of frequency components for the second frame with a first threshold, and
wherein the first threshold is determined based on the DC component value among the plurality of frequency components for the first frame.

4. The method of claim 1, wherein the sensing of whether the event occurs comprises:
determining whether the plurality of frequency components for the second frame are changed at a ratio with respect to the plurality of frequency components for the first frame; and
sensing whether an ambient lighting change occurs in the digital image corresponding to the second frame based on the determined result.

5. The method of claim 4, wherein the determining of whether the plurality of frequency components for the second frame are changed at the ratio with respect to the plurality of frequency components for the first frame comprises:
comparing a difference between a formula associated with a DC component value and an alternating current (AC) component value among the plurality of frequency components for the first frame and a formula associated with a DC component value and an AC component value among the plurality of frequency components for the second frame with a second threshold.

6. The method of claim 1, wherein the sensing of whether the event occurs further comprises:
encoding the digital image corresponding to the second frame based on a video image compression scheme using a high-compression encoder, if the event occurs in the digital image corresponding to the second frame.

7. The method of claim 6, whether the encoding of the digital image corresponding to the second frame based on the video image compression scheme comprises:
storing the encoded digital image corresponding to the second frame.

8. The method of claim 1, wherein the sensing of whether the event occurs in the digital image corresponding to the second frame comprises:
sensing whether the event occurs in the digital image corresponding to the second frame using the at least one of the plurality of frequency components for the first frame and the at least one of the plurality of frequency components for the second frame, over the entire region of the digital image.

9. The method of claim 1, further comprising:
obtaining a plurality of frequency components of a frequency domain from a digital image of a pixel domain using a low-power encoder,
wherein the plurality of frequency components are discrete cosine transform (DC) coefficients.

10. A computer-readable recording medium storing embodied thereon a program for executing the method of claim 1.

11. An event sensing system using a frequency component in a surveillance camera, the system comprising:
an obtaining unit configured to obtain at least one of a plurality of frequency components for a first frame of a digital image and at least one of a plurality of frequency components for a second frame subsequent to the first frame of the digital image; and
a sensing unit configured to sense whether an event occurs in a digital image corresponding to the second frame using the at least one of the plurality of frequency components for the first frame and the at least one of the plurality of frequency components for the second frame.

12. The system of claim 11, wherein the sensing unit senses a change between a DC component value among the plurality of frequency components for the first frame and a DC component value among the plurality of frequency components for the second frame.

13. The system of claim 12, wherein the sensing unit compares a change amount between the DC component value among the plurality of frequency components for the first frame and the DC component value among the plurality of frequency components for the second frame with a first threshold.

14. The system of claim 11, wherein the sensing unit determines whether the plurality of frequency components for the second frame are changed at a ratio with respect to the plurality of frequency components for the first frame and senses whether an ambient lighting change occurs in the digital image corresponding to the second frame based on the determined result.

15. The system of claim 14, wherein the sensing unit compares a difference between a formula associated with a DC component value and an AC component value among the plurality of frequency components for the first frame and a formula associated with a DC component value and an AC component value among the plurality of frequency components for the second frame with a second threshold.
